(19) United States
(12) Patent Application Publication
(10) Pub. No.: US 2018/0269528 A1
(43) Pub. Date: Sep. 20, 2018

(54) ELECTROLYTE FOR LTO TYPE LITHIUM ION BATTERIES

(71) Applicant: SHENZHEN CAPCHEM TECHNOLOGY CO., LTD, Shenzhen, Guangdong (CN)

(72) Inventors: Zhenghua Zhang, Suzhou, Jiangsu (CN); Xueshan Hu, Suzhou, Jiangsu (CN)

(73) Assignee: SHENZHEN CAPCHEM TECHNOLOGY CO., LTD, Shenzhen, Guangdong (CN)

(21) Appl. No.: 15/760,799

(22) PCT Filed: Sep. 23, 2015
(86) PCT No.: PCT/CN2015/090353

§ 371 Date: Mar. 16, 2018

(51) Int. Cl. H01M 10/0567; H01M 10/0525; H01M 10/0568; H01M 10/0569; H01M 4/36; H01M 4/485; H01M 4/587; H01M 4/525; H01M 4/505; H01M 4/62; H01M 4/131; H01M 10/42

(52) U.S. Cl. CPC H01M 10/0567; H01M 10/0525; H01M 10/0568; H01M 10/0569; H01M 4/366; H01M 4/485; H01M 2004/027; H01M 4/525; H01M 4/505; H01M 4/628; H01M 4/131; H01M 10/4235; H01M 4/587

(57) ABSTRACT

A lithium ion battery comprising at least one cathode, at least one anode comprising LTO having an optional surface coating, and an electrolyte composition, where the electrolyte composition comprises an organic solvent, one or more lithium salts, one or more SEI forming additives selected from the group consisting of a) alkali metal salts of borates, b) organoboron compounds, c) imides, d) sulfates and e) sulfites; and one or more moisture removing additives selected from the group consisting of f) anhydrides g) nitriles, h) tertiary amines, and i) amides.

This invention is related to non-aqueous electrolyte compositions for lithium titanium oxide (LTO) type lithium ion batteries.

Interest in Li-ion batteries using LTO anode has increased in recent years due to LTO's characteristic power capability, long life, and safety. However high temperature exposure can lead to power loss, gas generation, and decreased life.

LTO related high temperature performance degradation mechanisms have been the subject of study in the electrochemical literature and typically focus on the interfacial chemical reactivity of the LTO surface with electrolyte. One proposed mechanism includes catalytic electrolyte degradation involving the Ti³⁺—O sites leading to gassing and solid degradation products, while another proposes direct reduction of electrolyte at the LTO/electrolyte interface resulting in growth of thin surface films, LTO surface delithiation and LTO phase transformation. The presence of water and other impurities are believed to accelerate the above two mechanisms. Strategies to decrease this interfacial electrolyte activity typically include establishing a thin passivating, ionically conducting interface that reduces reactivity with the electrolyte. This can be accomplished through different methods including surface treatment of LTO powder, addition of functional additives to the electrolyte, and optimization of formation procedures.

US2014113197 and US20130236784 disclose surface coating such as LiF, Al₂O₃ or carbon coating to suppress gas generation. U.S. Pat. No. 9,017,883 discloses using a combination of sultone-based compound and maleic anhydride to reduce gassing. U.S. Pat. No. 8,168,330, CN103840191A and CN102867990A disclose employing lithium borate or lithium borate in combination with phosphazene to reduce gassing to a certain extent. US20130273427 discloses using moisture scavengers to reduce gas, but no suitable examples are given. Further improvements are still needed.

The present invention provides a surprisingly effective system that reduces gas generation for LTO type lithium ion batteries, especially at elevated temperature.

### DETAILED DESCRIPTION

Lithium ion batteries (cells) comprise an anode capable of intercalating and disintercalating lithium ions, a cathode and a non-aqueous electrolyte solution containing a lithium salt in an organic solvent. The electrodes are in contact with the electrolyte and are separated by a separator.

Cathode active materials include one or more compounds selected from the group consisting of lithium transition metal oxide and lithium transition metal phosphate, for example, lithium cobalt oxide, lithium nickel cobalt manganese oxide (NCM, LiₓNi_{y}Mn_{z}Co_{1-(y+z)}O₂), lithium manganese oxide (LMO, LiMn₂O₄), lithium nickel oxide and lithium iron phosphate (LFP, LiFePO₄).

Anode active materials include one or more compounds selected from the group comprising lithium titanium oxide (LTO), for example Li₄Ti₅O₁₂, Li₂Ti₃0₇, LixTiO₂, TiO₂, TiO₂(OH)x and mixtures thereof. The anode active material can additionally be coated with LiF, Al₂O₃ or carbon surface coating.

Anode active materials include mixtures of the above-mentioned anode active materials and carbonaceous materials, wherein the carbonaceous materials are selected from the group comprising graphite, hard carbon, amorphous carbon, carbon-containing core-shell material and silicon containing material.

In addition to the cathode and anode active materials, the electrodes may further include binders and/or conductive materials and/or other additives. The electrode assemblies may include these mixtures in adherence to a current collector such as a metal foil.

The binder assists in coupling the active material and the conductive material and the mixture to the current collector. Binders include poly(tetrafluoroethylene) (PTFE), a copolymer of acrylonitrile and butadiene (NBR), polyvinylidene fluoride (PvDF), polyvinyl alcohol, carboxy methyl cellulose (CMC), starch, hydroxy propyl cellulose, regenerated cellulose, polyvinylpyrrolidone, tetrafluoroethylene, polyethylene, polypropylene, ethylene-propylene-diene polymer (EPDM), sulfonated-EPDM, styrene-butadiene rubber (SBR), fluorine rubber, copolymers thereof and mixtures thereof. Binders may be employed from about 1 to about 50 weight %, based on the total weight of electrode assembly.

Conductive materials include graphitic materials such as natural graphite, artificial graphite, a carbon black such as acetylene black, Ketjen black, channel black, furnace black or lamp black, conductive fibers such as carbon fiber or metal fiber, metal powders such as carbon fluoride, aluminum or nickel powder, conductive metal oxides such as zinc oxide, potassium titanate or titan oxide and other conductive materials such as polyphenylene derivatives. Conductive materials may be from about 1 to about 20 weight %, based on the total weight of the electrode assembly.

A separator is interposed between the cathode and the anode which is for instance an insulating thin film ensuring high ion transmission. The separator generally has a pore size of about 0.01 to about 10 microns and a thickness of about 5 to about 300 microns. Separator materials include sheets or non-woven fabrics comprising materials including glass fiber, cotton, nylon, polyester, polyethylene, polypropylene, polyvinyl chloride, polytetrafluoroethylene and kraft paper.

The lithium ion battery may for example be a coin-type battery having a cathode, an anode and a single-layer or multi-layer separator or a cylindrical or angled battery having a cathode, an anode and a roll-type separator.

The cathode may be prepared by mixing cathode active material with conductive material and/or a binder and a solvent, coating a metal foil with the mixture and heating and rolling. The anode may be prepared by mixing anode active material with a binder and solvent, coating a metal foil with the mixture and heating and rolling.

The lithium ion battery according to the present invention may be prepared by inserting an electrode group having a cathode and an anode into a battery case and injecting the non-aqueous electrolyte solution of the present invention into the case. The battery case may have a metal can shape or a pouch shape made of metal laminate.

The present electrolyte compositions are anhydrous, typically containing ≤10 ppm water, for instance ≤9, ≤8, ≤7, ≤6, ≤5 or ≤4 ppm water by weight, based on the total weight of the electrolyte composition.

The term “SEI forming additives” here are compounds which are added to an electrolyte composition to improve the SEI formation. (SEI=solid electrolyte interphase)

The term “moisture removing additives” here are compounds which are added to an electroyle composition to reduce the content of water.

The organic solvent typically comprises one or more solvents selected from the group consisting of organic carbonates.

Organic carbonates can be cyclic or acyclic and include ethylene carbonate (EC), propylene carbonate (PC), trimethylene carbonate, 1,2-butylene carbonate (BC), dimethyl carbonate (DMC), diethyl carbonate (DEC), ethylmethyl carbonate (EMC), dipropyl carbonate, vinylene carbonate, difluoroethylene carbonate and monofluoroethylene carbonate.

For example, at least two different solvents are advantageously used in combination, such as a combination of cyclic carbonate and linear carbonate, a combination of cyclic carbonate and lactone, a combination of cyclic carbonate, lactone and ester, a combination of cyclic carbonate, linear carbonate and lactone, a combination of cyclic carbonate, linear carbonate and ether or a combination of cyclic carbonate, linear carbonate and linear ester. Among them, a combination of cyclic carbonate and linear carbonate or a combination of cyclic carbonate, lactone and ester is preferred. A weight:weight ratio of cyclic carbonate(s) to linear carbonate(s) is for example from about 1:9 to about 7:3.

For example, the organic solvent contains a cyclic carbonate such as ethylene carbonate or propylene carbonate and one or more linear carbonates selected from dimethyl carbonate, ethylmethyl carbonate and diethyl carbonate. For example, the organic solvent comprises ethylene carbonate, ethylmethyl carbonate and diethyl carbonate.

The electrolyte compositions comprise one or more suitable lithium salts. Lithium salts include LiPF₆, LiBF₄, LiClO₄, LiN(CF₃SO₂)₂, LiAsF₆ and LiCF₃SO₃. For example, the electrolyte compositions contain LiPF₆. The lithium salts are generally employed in the organic solvent at a level of from about 0.5 mol/L (M) to about 2.5 M, from about 0.5 M to about 2.0 M, from about 0.7 M to about 1.6 M or from about 0.8 M to about 1.2 M.

The cyclic sulfate additives are for example of formula

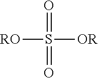

wherein the R groups together are hydrocarbylene.

For example sulfate additives included are 1,3,2-dioxathiolane 2,2-dioxide (ethylene sulfate), 1,3-propanediol cyclic sulfate, propylene sulfate (4-methyl-1,3,2-dioxathiolane 2,2-dioxide), 4-ethyl-1,3,2-dioxathiolane 2,2-dioxide and 4-propyl-1,3,2-dioxathiolane 2,2-dioxide.

Ethylene sulfate, or 1,3,2-dioxathiolane 2,2-dioxide (DTD) is represented as:

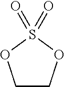

Tertiary amines include compounds of formula NR₁R₂R₃ wherein R₁, R₂ and R₃ are each hydrocarbyl or wherein R₁ and R₂ and/or R₁ and R₃ and/or R₂ and R₃ together are hydrocarbylene. Tertiary amines include for instance triethylamine, tributylamine, N,N,N′,N″,N″-pentamethyldiethylenetriamine (PMDTA), N,N,N′,N″,N′″,N′″-hexamethyltriethylenetetraamine (HMTTA), N,N,N′,N′-tetramethylethylenediamine (TMEDA) and triethylenediamine (1,4-diazabicyclo[2.2.2]octane or DABCO). Triethylenediamine is an example wherein R₁ and R₂ and R₁ and R₃ and R₂ and R₃ together are hydrocarbylene.

Amides include organic amides and phosphoramides. Organic amides include compounds of formula R₁R₂NC(O)R₃ wherein R₁, R₂ and R₃ are each hydrogen or hydrocarbyl or R₁ and R₂ and/or R₁ and R₃ and/or R₂ and R₃ together are hydrocarbylene. Amides include N,N-dimethyl acetamide, N,N-dimethyl-trifluoroacetamide, N,N-diethyl-trifluoroacetamide, N-methyl-trifluoracetamide, 1-methyl-2-pyrrolidinone and hexamethylphosphoramide (HMPA).

Organoboron compounds include compounds of formula

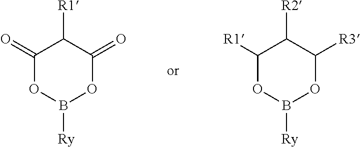

wherein Ry is hydrogen, alkoxy or hydrocarbyl and R1′, R2′ and R3′ are hydrogen or hydrocarbyl. Organoboron compounds include 4,4,6-trimethyl-1,3,2-dioxaborinane, 2-methoxy-4,4,6-trimethyl-1,3,2-dioxaborinane, 2-ethoxy-4,4,6-trimethyl-1,3,2-dioxaborinane, 2-isopropoxy-4,4,6-trimethyl-1,3,2-dioxaborinane, 2-butoxy-4,4,6-trimethyl-1,3,2-dioxaborinane, vinylboronic acid 2-methyl-2,4-pentanediol ester, phenylboronic acid neopentylglycol ester and phenylboronic acid 1,3-propanediol ester.

Borate salts include alkali metal salts of borates selected from orthoborate, tetrahydroxyborate, tetraborate, tetraphenylborate, [B(3,5-(CF₃)₂C₆H₃)₄]⁻ (BARF), di(trifluoroacetato)oxalatoborate (D(Ac)OB), and B(C₆F₅)₄⁻.

For instance, lithium bis (oxalate) borate (LiBOB), lithium malonic acid oxalate borate (LiMOB), lithium difluoro oxalate borate (LiDFOB), lithium bis[1,2-benzenediolato(2-)-O,O′]borate (LBBB), lithium bis[2,3-naphthalenediolato(2-)-O,O′]borate (LBNB), lithium bis[2,2′-biphenyldiolato(2-)-O,O′]borate (LBBPB) and lithium bis[salicylato(2-)]borate (LBSB), lithium bis (2,3-pyridinedicarboxylic oxy) borate (LBPB), lithium trifluoroacetic acid perfluoro-substituted phenyl (LiBF3C6F5), lithium bismalonic borate(LiBMB).

Anhydrides are cyclic or acyclic and include organic and phosphonic anhydrides. Organic anhydrides include compounds of formula

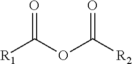

wherein R₁ and R₂ are hydrocarbyl or together are hydrocarbylene.

Included are succinic anhydride, glutaric anhydride, phthalic anhydride, acetic anhydride, maleic anhydride, naphthalic anhydride, propionic anhydride, citraconic anhydride, butyric anhydride, 3,4,5,6-tetrahydrophthalic anhydride, isatoic anhydride, valeric anhydride and propylphosphonic anhydride.

Nitriles include organic mono and di-nitriles, including compounds of formula

R—CN NC-Rz-CN

or

wherein R₁ is hydrocarbyl and Rz is hydrocarbylene.

for example acetonitrile, propionitrile, butyronitrile, isobutyronitrile, 1,2-dicyanoethane, succinonitrile, 1,5-dicyanopentane, hexanedinitrile (adiponitrile), glutaronitrile and fumaronitrile.

Hydrocarbyl is for instance alkyl, alkenyl, alkynyl, cycloalkyl, cycloalkenyl, aryl or aralkyl, which may be substituted by one or more groups selected from the group consisting of halogen, hydroxy, C₁-C₄alkoxy, thio, C₁-C₄alkylthio, amino, C₁-C₄alkylamino, di-C₁-C₄alkylamino, nitro, cyano, —COON and —COO⁻. Hydrocarbyl may also be interrupted by one or more groups selected from the group consisting of —O—, —S—, —NH— and —N(C₁-C₄alkyl)-. Hydrocarbyl may be both substituted by one or more of said groups and interrupted by one or more of said groups. For instance alkyl, alkenyl, alkynyl, cycloalkyl, cycloalkenyl, aryl or aralkyl may be substituted by one to three groups selected from the group consisting of chloro, hydroxy, methoxy, ethoxy, propoxy, butoxy, thio, methylthio, methylamino, ethylamino, propylamino, butylamino, dimethylamino, diethylamino, dipropylamino, dibutylamino, —COON, —COO⁻, cyano and nitro and/or may be interrupted by one to three groups selected from the group consisting of —O—, —S—, —NH— and —N(C₁-C₄alkyl)-.

Hydrocarbylene is divalent hydrocarbyl, for instance alkylene, alkenylene, alkynylene, cycloalkylene, arylene or aralkylene. Hydrocarbylene may be substituted and/or interrupted as is hydrocarbyl.

When two groups together are hydrocarbylene, this means that together with the heteroatom(s) they are bound to, a resulting ring is formed. The ring is for example 5- or 6-membered. The ring may contain a further heteroatom and may be saturated or unsaturated. Hydrocarbylene in this case is for instance —(CH₂)₂—, —(CH₂)₃—, —(CH₂)₄— or —(CH₂)₅—. Hydrocarbylene may be interrupted and/or substituted as for hydrocarbyl.

Hydrocarbyl and hydrocarbylene are bound to the attached atom through a carbon atom.

Alkyl is for instance from 1 to 25 carbon atoms, is branched or unbranched and includes methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl, icosyl and docosyl.

Alkoxy is for instance C₁-C₂₅alkyloxy wherein the alkyl is as above, for instance methoxy, ethoxy, propoxy, isopropoxy, butoxy, tert-butoxy, etc.

Halogen is F, Cl, Br or I.

Haloalkyl is for instance C₁-C₂₅alkyl wherein alkyl is as above, substituted by one or more, for instance 1 to 3 halogen.

Perfluoroalkyl may be fully fluorinated, that is all hydrogens of the alkyl are replaced by F. Alternatively, perfluoroalkyl may be partly fluorinated, that is containing at least 2 groups selected from —CF₂— and —CF₃.

Alkenyl is an unsaturated version of alkyl, for instance allyl.

Alkynyl is alkyl containing a

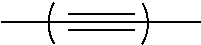

group, for instance, propargyl.

Cycloalkyl includes cyclopentyl, methylcyclopentyl, dimethylcyclopentyl, cyclohexyl, methylcyclohexyl, dimethylcyclohexyl, trimethylcyclohexyl, tert-butylcyclohexyl, cycloheptyl or cyclooctyl.

Cycloalkenyl is an unsaturated version of cycloalkyl.

Aryl includes phenyl, o-, m- or p-methylphenyl, 2,3-dimethylphenyl, 2,4-dimethylphenyl, 2,5-dimethylphenyl, 2,6-dimethylphenyl, 3,4-dimethylphenyl, 3,5-dimethylphenyl, 2-methyl-6-ethylphenyl, 4-tert-butylphenyl, 2-ethylphenyl or 2,6-diethylphenyl.

Aralkyl includes benzyl, methylbenzyl, dimethylbenzyl and 2-phenylethyl.

The additives from a)-i), single component or combined in total, are present from about 0.01 to about 15%, are employed for example from about 0.01% to about 15% by weight, based on the total weight of the electrolyte composition. For example, these additives in total may be present from about 0.1 to about 12%, from about 0.2 to about 10%, from about 0.3 to about 8%, from about 0.4 to about 7% or from about 0.5 to about 5% by weight, based on the total weight of the electrolyte composition.

The weight:weight ratio of the two different additives from a)-i) is for instance about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1 or about 9:1 and ratios therebetween.

Advantageously, at least one additive is selected from the group consisting of borate salts, anhydrides and nitriles. More advantageously, two different additives are selected from the groups of borate salts, anhydrides or nitriles.

The electrolyte compositions of the invention may advantageously comprise one or more further additives selected from the group consisting of solid electrolyte interface improvers, cathode protection agents, LiPF₆ stabilizers, overcharge protectors, flame retardants, Li deposition improvers, solvation enhancers, corrosion inhibitors, wetting agents and viscosity adjusting agents.

For instance, the electrolyte compositions may further contain one or more further additives selected from the group consisting of formulae (1) to (12)

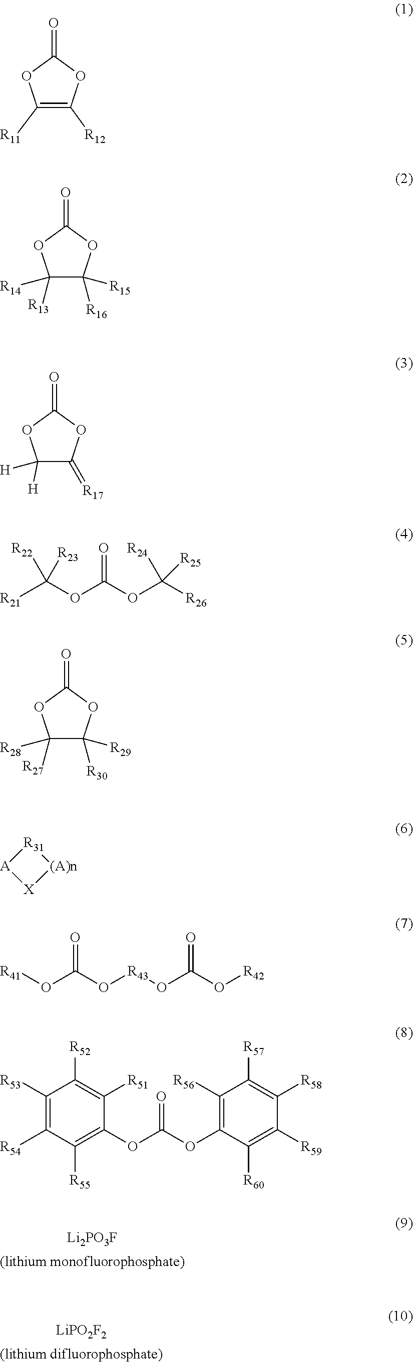

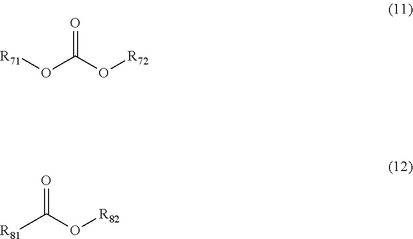

wherein
R₁₁ and R₁₂ are independently hydrogen, halogen, alkyl or haloalkyl;
R₁₃, R₁₄, R₁₅ and R₁₆ are independently hydrogen, halogen, alkyl, haloalkyl, vinyl or allyl, wherein at least one of R₁₃ to R₁₆ is vinyl or allyl;
R₁₇ is hydrogen or alkyl;
R₂₁ to R₂₆ are independently hydrogen, halogen, alkyl or haloalkyl, wherein at least one of R₂₁ to R₂₆ is halogen or haloalkyl;
R₂₇ to R₃₀ are independently hydrogen, halogen, alkyl or haloalkyl, wherein at least one of R₂₇ to R₃₀ is halogen or haloalkyl;
R₃₁ is an optionally substituted C₁-C₆alkylene, an optionally substituted C₂-C₆alkenylene or an optionally substituted cycloalkylene, A is C═O, SO or SO₂, n is 0 or 1 and X is oxygen (O) or sulfur (S);
R₄₁ and R₄₂ are independently an optionally substituted C₁-C₆alkyl, an optionally substituted C₂-C₆alkenyl or an optionally substituted C₂-C₆alkynyl and R₄₃ is an optionally substituted C₁-C₆alkylene, an optionally substituted C₂-C₆alkenylene, an optionally substituted C₂-C₆alkynylene or an optionally substituted cycloalkylene, wherein the substituent is for instance halogen or C₁-C₆alkyl;
R₅₁ to R₆₀ independently are an optionally substituted C₁-C₁₈alkyl, alkenyl, alkynyl, alkoxy or alkylamino, or two of R₅₁-R₆₀ together are hydrocarbylene, wherein the substituent halogen atom or C₁-C₆alkyl;
R₇₁ and R₇₂ are independently alkyl or haloalkyl; and
R₈₁ and R₈₂ are independently alkyl,

For example, suitable further additives include vinylene carbonate (1,3-dioxol-2-one), 4-vinyl-1,3-dioxolan-2-one, 4-fluoro-1,3-dioxolan-2-one, methylene ethylene carbonate, 1,3-propane sultone, 1,4-butyl sultone, prop-1-ene-1,3-sultone, 4-(4-methye-1,3,2-dioxathiolane-2-oxide) and 1,5,2,4-dioxadithiane-2,2,4,4-tetraoxide.

Further additives also include one or more ionic compounds selected from the group consisting of ionic liquids. Ionic liquids are ionic compounds that exhibit a melting point of 150° C. or ≤100° C.

For instance, ionic liquids contain a cation selected from the group consisting of formulae (a)-(h)

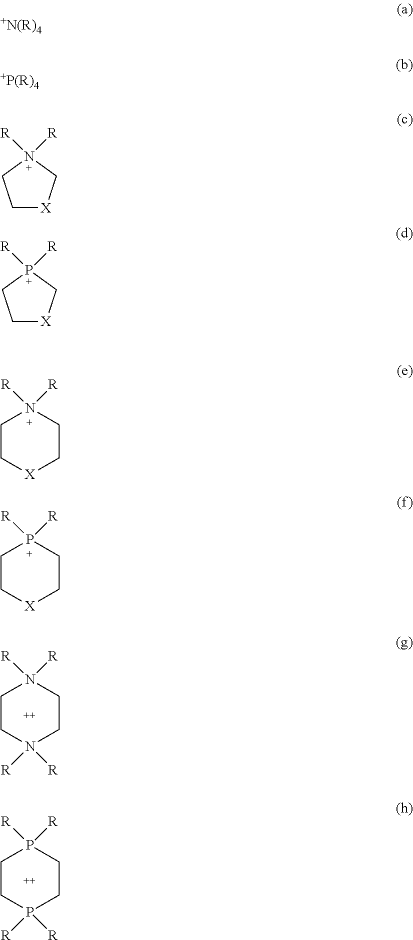

wherein
each R is independently H or C₁-C₁₆alkyl, for instance methyl, ethyl or propyl,
X is CH₂, O, S or NR wherein R is H or C₁-C₁₆alkyl, for instance H, methyl, ethyl or propyl and contain an anion selected from the group consisting of

[F_{z}B(CₘF2ₘ₊₁)_{4-z}]⁻,

[F_{y}P(CₘF₂ₘ₊₁)_{6-y}]⁻,

[(CₘF₂ₘ₊₁)₂P(O)O]⁻,

[CₘF₂ₘ₊₁P(O)O₂]²⁻,

[O—C(O)—CₘF₂ₘ₊₁]⁻,

[O—S(O)₂—CₘF₂ₘ₊₁]⁻,

[N(C(O)—CₘF₂ₘ₊₁)₂]⁻,

[N(S(O)₂—CₘF₂ₘ₊₁)₂]⁻,

[N(C(O)—CₘF₂ₘ₊₁)(S(O)₂—CₘF₂ₘ₊₁)]⁻,

[N(C(O)—CₘF₂ₘ₊₁)(C(O)F)]⁻,

[N(S(O)₂—CₘF₂ₘ₊₁)(S(O)₂F)]⁻,

[N(S(O)₂F)₂]⁻,

[C(C(O)—CₘF₂ₘ₊₁)₃]⁻,

[C(S(O)₂—CₘF₂ₘ₊₁)₃]⁻,

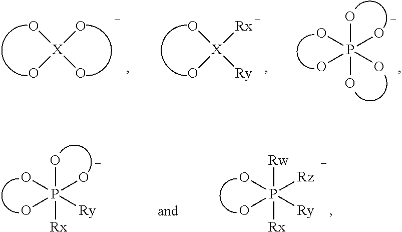

wherein
y is an integer of 1 to 5 and m is an integer of 1 to 8, for instance 1 to 4,
wherein any one CF₂ group may be replaced by O, S(O)₂, NR or CH₂,
wherein

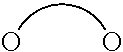 [SMILES: O ; O]

is independently a bidentate group derived from the —OH groups of a 1,2- or 1,3-diol, a 1,2- or 1,3-dicarboxylic acid or from a 1,2- or 1,3-hydroxycarboxylic acid,
X is B or Al,
R_{w}, Rₓ, R_{y} and R_{z} are independently halogen, C₁-C₂₀perfluoroalkyl, C₁-C₂₀alkoxy, C₁-C₂₀alkoxy which is partly or fully fluorinated, C₁-C₂₀alkyl-COO, C₁-C₂₀alkyl-COO which is partly or fully fluorinated.

Cations of ionic liquids include ammonium and phosphonium ions. Ammonium ions include imidazolium and pyrrolidinium. For instance 1-ethyl-3-methylimidazolium, 1-hexyl-3-methylimidazolium, 1-butyl-1-methylpyrrolidinium or trihexyl(tetradecyl)phosphonium.

Anions of ionic liquids include carboxylates, imides, methides, borates, phosphates, sulfonates and aluminates. For instance, included are F₂P(C₂F₅)₄⁻, F₃P(C₂F₅)₃⁻, F₄P(C₂F₅)₂⁻, F₂P(C₃F₇)₄⁻, F₃P(C₃F₇)₃⁻, F₄P(C₃F₇)₂⁻, F₂P(C₄F₉)₄⁻, F₃P(C₄F₉)₃⁻, F₄P(C₄F₉)₂⁻, perfluoroalkylcarboxylate, perfluoroalkylsulfonate, bis(perfluoroalkylsulfonyl)imide, (perfluoroalkylsulfonyl)(perfluoroalkylcarboxyl)imide, tris(perfluoroalkylsulfonyl)methide, trifluoroacetate, trifluoromethanesulfonate (triflate), bis(trifluoromethylsulfonyl)imide, tris(trifluoromethylsulfonyl)methide, spiro-oxo borates and spiro-oxo phosphates, for example bisoxalatoborate (BOB), difluorooxalatoborate (dFOB), di(trifluoroacetato)oxalatoborate (d(Ac)OB), trisoxalatophosphate, tetrafluorooxalatophosphate or di(trifluoroacetato)oxalatoaluminate.

Ionic liquids are also described for example in U.S. Pub. Nos. 2011/0045359 and 2014/0193707.

These further additives are for example employed at a level of from about 0.01% to about 15% by weight, based on the total weight of the electrolyte composition. For example, further additives may be employed from about 0.1 to about 10%, from about 0.2 to about 7% or from about 0.3 to about 5%, by weight, in total, based on the total weight of the electrolyte composition.

Further additives may be employed at a level, in total, of about 0.4, about 0.5, about 0.6, about 0.7, about 0.8, about 0.9, about 1.0, about 1.1, about 1.2, about 1.3, about 1.4, about 1.5, about 1.6, about 1.7, about 1.8, about 1.9, about 2.0, about 2.1, about 2.2, about 2.3, about 2.4 or about 2.5 percent by weight, based on the total weight of the electrolyte composition.

The terms “a” or “an” referring to elements of an embodiment may mean “one” or may mean “one or more”.

The term “about” refers to variation that can occur, for example, through typical measuring and handling procedures; through inadvertent error in these procedures; through differences in the manufacture, source, or purity of ingredients used; through differences in methods used; and the like. The term “about” also encompasses amounts that differ due to different equilibrium conditions for a composition resulting from a particular initial mixture. Whether or not modified by the term “about,” embodiments and claims include equivalents to the recited quantities.

All numeric values herein are modified by the term “about,” whether or not explicitly indicated. The term “about” generally refers to a range of numbers that one of skill in the art would consider equivalent to the recited value (i.e., having the same function and/or result). In many instances, the term “about” may include numbers that are rounded to the nearest significant figure.

A value modified by the term “about” of course includes the specific value. For instance, “about 5.0” must include 5.0.

The term “consisting essentially of” means that the composition, method or structure may include additional ingredients, steps and/or parts, but only if the additional ingredients, steps and/or parts do not materially alter the basic and novel characteristics of the claimed composition, method or structure.

U.S. Patents, U.S. published patent applications and U.S. patent applications discussed herein are each hereby incorporated by reference.

### Illustrative Embodiments

E1. A lithium ion battery comprising at least one cathode, at least one anode comprising LTO having an optional surface coating, and an electrolyte composition,
where the electrolyte composition comprises an organic solvent, one or more lithium salts, one or more SEI forming additives selected from the group consisting of a) alkali metal salts of borates, b) organoboron compounds, c) imides, d) sulfates and e) sulfites; and one or more moisture removing additives selected from the group consisting of f) anhydrides g) nitriles, h) tertiary amines, and i) amides.

E1.1 The battery according to E1, where the concentration of the additives, in total, are presented from about 0.01% to about 15%, from about 0.1 to about 10%, from about 0.2 to about 7% or from about 0.3 to about 5%, by weight based on the total weight of the electrolyte composition.
E2. The battery according to E1, wherein the one or more SEI forming additives a)-e) are selected from the group consisting of
a) lithium salts of borates;
b) organoboron compounds of formula

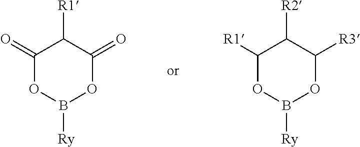

wherein Ry is hydrogen, alkoxy or hydrocarbyl and R1′, R2′ and R3′ are hydrogen or hydrocarbyl;

c) fluorosulfonyl imides;
d) sulfates of formula

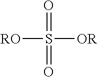

wherein the R groups are hydrocarbyl or together are hydrocarbylene; and
e) sulfites of formula

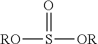

wherein the R groups are hydrocarbyl or together are hydrocarbylene;
and where the one or more moisture removing additives f)-i) are selected from the group consisting of
f) anhydrides of formula

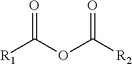

wherein R₁ and R₂ are independently hydrocarbyl or together are hydrocarbylene;
g) nitriles of formula

R₁—CN or NC-Rz-CN

wherein R₁ is hydrocarbyl and Rz is hydrocarbylene;
h) tertiary amines of formula NR₁R₂R₃ wherein R₁, R₂ and R₃ are each hydrocarbyl or wherein R₁ and R₂ and/or R₁ and R₃ and/or R₂ and R₃ together are hydrocarbylene; and
i) amides of formula

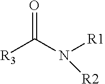

wherein R₁, R₂ and R₃ are each hydrocarbyl or wherein R₁ and R₂ and/or R₁ and R₃ and/or R₂ and R₃ together are hydrocarbylene;
E3. The battery according to E1 or E2, wherein the one or more SEI forming additives a)-e) are selected from the group consisting of
a) lithium bis (oxalate) borate (LiBOB), lithium malonic acid oxalate borate (LiMOB), lithium difluoro oxalate borate (LiDFOB), lithium bis[1,2-benzenediolato(2-)-O,O′]borate (LBBB), lithium bis[2,3-naphthalenediolato(2-)-O,O′]borate (LBNB), lithium bis[2,2′-biphenyldiolato(2-)-O,O′]borate (LBBPB) and lithium bis[salicylato(2-)]borate (LBSB), lithium bis (2,3-pyridinedicarboxylic oxy) borate (LBPB), lithium trifluoroacetic acid perfluoro-substituted phenyl (LiBF3C6F5), or lithium bismalonic borate(LiBMB);
b) 4,4,6-trimethyl-1,3,2-dioxaborinane, 2-methoxy-4,4,6-trimethyl-1,3,2-dioxaborinane, 2-ethoxy-4,4,6-trimethyl-1,3,2-dioxaborinane, 2-isopropoxy-4,4,6-trimethyl-1,3,2-dioxaborinane, 2-butoxy-4,4,6-trimethyl-1,3,2-dioxaborinane, vinylboronic acid 2-methyl-2,4-pentanediol ester, phenylboronic acid neopentylglycol ester, or phenylboronic acid 1,3-propanediol ester;
c) Lithium bis(fluorosulfonyl) imide (LiFSI) or lithium bis(perfluoromethylsulfonyl)imide (LiTFSI);
d) 1,3,2-dioxathiolane 2,2-dioxide (ethylene sulfate, DTD), 1,3-propanediol cyclic sulfate, or 4-methyl-1,3,2-dioxathiolane 2,2-dioxide; and
e) Ethylene sulfite, or trimethylene sulfite;
and the one or more moisture removing additives f)-i) are selected from the group consisting of
f) succinic anhydride (SA), glutaric anhydride (GA), phthalic anhydride (PA), acetic anhydride, maleic anhydride, naphthalic anhydride, propionic anhydride, citraconic anhydride, butyric anhydride, 3,4,5,6-tetrahydrophthalic anhydride, isatoic anhydride, valeric anhydride, or propylphosphonic anhydride;
g) acetonitrile, propionitrile, butyronitrile, isobutyronitrile, 1,2-dicyanoethane, succinonitrile, 1,5-dicyanopentane, hexanedinitrile (adiponitrile), glutaronitrile, or fumaronitrile;
h) triethylamine, tributylamine, N,N,N′,N″,N″-pentamethyldiethylenetriamine, N,N,N′,N″,N′″,N′″-hexamethyltriethylenetetraamine, N,N,N′,N′-tetramethylethylenediamine, or triethylenediamine; and
i) N,N-dimethyl acetamide, N,N-dimethyl-trifluoroacetamide, N,N-diethyl-trifluoroacetamide, N-methyl-trifluoracetamide, 1-methyl-2-pyrrolidinone, or hexamethylphosphoramide;
E4. The battery according to any of E1 to E3 comprising one or more SEI forming additives a) alkali metal salts of borates.

E4.1 The battery according to E4 comprising lithium bis (oxalate) borate (LiBOB), lithium malonic acid oxalate borate (LiMOB), lithium difluoro oxalate borate (LiDFOB), lithium bis[1,2-benzenediolato(2-)-O,O′]borate (LBBB), lithium bis[2,3-naphthalenediolato(2-)-O,O]borate (LBNB), lithium bis[2,2′-biphenyldiolato(2-)-O,O]borate (LBBPB) and lithium bis[salicylato(2-)]borate (LBSB), lithium bis (2,3-pyridinedicarboxylic oxy) borate (LBPB), lithium trifluoroacetic acid perfluoro-substituted phenyl (LiBF3C6F5), or lithium bismalonic borate(LiBMB).
E5. The battery according to E5 comprising one or more SEI forming additives d) sulfates.

E5.1 The battery according to E5 comprising 1,3,2-dioxathiolane 2,2-dioxide (ethylene sulfate, DTD), 1,3-propanediol cyclic sulfate, or 4-methyl-1,3,2-dioxathiolane 2,2-dioxide.
E6. The battery according to any of E1 to E5 comprising one or more moisture removing additives f) anhydrides.

E.6.1 The battery according to E6 comprising f) succinic anhydride (SA), glutaric anhydride (GA), phthalic anhydride (PA), acetic anhydride, maleic anhydride, naphthalic anhydride, propionic anhydride, citraconic anhydride, butyric anhydride, 3,4,5,6-tetrahydrophthalic anhydride, isatoic anhydride, valeric anhydride, or propylphosphonic anhydride
E7. The battery according to any of E1 to E3 comprising one or more additives a), one or more additives d), and optionally one or more additives f).

E7.1 The battery according to E7 comprising one or more additives a) comprising lithium bis (oxalate) borate (LiBOB), lithium malonic acid oxalate borate (LiMOB), lithium difluoro oxalate borate (LiDFOB), lithium bis[1,2-benzenediolato(2-)-O,O′]borate (LBBB), lithium bis[2,3-naphthalenediolato(2-)-O,O′]borate (LBNB), lithium bis[2,2′-biphenyldiolato(2-)-O,O′]borate (LBBPB) and lithium bis[salicylato(2-)]borate (LBSB), lithium bis (2,3-pyridinedicarboxylic oxy) borate (LBPB), lithium trifluoroacetic acid perfluoro-substituted phenyl (LiBF3C6F5), or lithium bismalonic borate(LiBMB); and one or more additives d) 1,3,2-dioxathiolane 2,2-dioxide (ethylene sulfate, DTD), 1,3-propanediol cyclic sulfate, or 4-methyl-1,3,2-dioxathiolane 2,2-dioxide.

E7.2 The battery according to E7 comprising f) succinic anhydride (SA), glutaric anhydride (GA), phthalic anhydride (PA), acetic anhydride, maleic anhydride, naphthalic anhydride, propionic anhydride, citraconic anhydride, butyric anhydride, 3,4,5,6-tetrahydrophthalic anhydride, isatoic anhydride, valeric anhydride, or propylphosphonic anhydride.
E8. The battery according to any of E1 to E7, wherein the cathode comprising lithium transition metal oxide or lithium transition metal phosphate.

E8.1 The battery according to E8, wherein the cathode comprising lithium nickel cobalt manganese oxide (NCM) active material.
E9. The battery according to any of E1 to E8 wherein the LTO comprising a surface coating comprising carbon, AlF₃, or Al₂O₃.

E9.1 The battery according to E9, wherein the LTO comprising a surface coating comprising carbon.
E10. The battery according to any of E1 to E9 wherein the organic solvent comprising one or more organic carbonates selected from the group consisting of ethylene carbonate, propylene carbonate, trimethylene carbonate, 1,2-butylene carbonate, dimethyl carbonate, diethyl carbonate, ethylmethyl carbonate, dipropyl carbonate, vinylene carbonate, difluoroethylene carbonate and monofluoroethylene carbonate.
E11. The battery according to any of E1 to E10 wherein the lithium salts are selected from the group consisting of LiPF₆, LiClO₄, LiN(CF₃SO₂)₂, LiAsF₆, LiCF₃SO₃ and LiBF₄ and wherein the lithium salts in total are present in the organic solvent at a level of from about 0.5 M to about 2.5 M.
E12. The battery according to any of E1 to E11 wherein additives a)-i), in total, are present from about 0.01 to about 15%, by weight, based on the total weight of the electrolyte composition and wherein the weight:weight ratio of the SEI forming additives a)-e) to the moisture removing additives f)-i) is from about 1:9 to about 9:1.
E13. The battery according to any of E1 to E12 comprising one or more further additives selected from the group consisting of vinylene carbonate (1,3-dioxol-2-one), 4-vinyl-1,3-dioxolan-2-one, 4-fluoro-1,3-dioxolan-2-one, methylene ethylene carbonate, 1,3-propane sultone, 1,4-butyl sultone, prop-1-ene-1,3-sultone, 4-(4-methye-1,3,2-dioxathiolane-2-oxide), 1,5,2,4-dioxadithiane-2,2,4,4-tetraoxide and ionic liquids.
E14. A method to reduce gassing and/or to improve capacity retention for LTO type lithium ion batteries at elevated temperature, the method comprising employing an electrolyte composition comprising an organic solvent, one or more lithium salts, one or more SEI forming additives selected from a group consisting of a) alkali metal salts of borates, b) organoboron compounds, c) imides, d) sulfate and e) sulfite ; and one or more moisture removing additives selected from the group consisting off) anhydrides, g) nitriles, h) tertiary amines, i) amides.
E15. A lithium ion battery comprising at least one cathode, at least one anode comprising LTO having an optional surface coating, and an electrolyte composition, where the electrolyte composition comprises an organic solvent, one or more lithium salts, and one or more additives selected from a group consisting of 1,3,2-dioxathiolane 2,2-dioxide (ethylene sulfate, DTD), 1,3-propanediol cyclic sulfate, and 4-methyl-1,3,2-dioxathiolane 2,2-dioxide, wherein the total weight of the additive is 0.01 to about 15%, by weight, based on the total weight of the electrolyte composition. For example from about 0.1 to about 10%, from about 0.2 to about 7% or from about 0.3 to about 5%, by weight.

### EXAMPLES

Cathode active material slurry was prepared by dispersing LixNi_{0.5}Co_{0.2}Mn_{0.3}O₂, NCM(523) cathode active material, polyvinylidene fluoride binder and carbon conductive material in N-methyl-2-pyrrolidone solvent in a weight ratio of 90:5:5. The cathode tape was formed by coating the slurry onto 20 micron thick aluminum foil followed by drying and rolling the coated foil.

Anode active material slurry is prepared by mixing Li4Ti5O12 (Example: with carbon coating vs. Comparative Example: without coating), polyvinylidene fluoride and carbon conductive material in a weight ratio of 88:7:5 and dispersing the mixture in N-methyl-2-pyrrolidone solvent. The anode slurry was coated onto a 20 um thick aluminum foil followed by drying and rolling the coated foil. The cathode tape and anode tape was cut with a puncher into an electrode plates with specific dimension. Then a 16 um thick polyethylene separator was placed between the electrodes plates and the assembly is stacked and pressurized. The assembly was inserted into an Al laminated film pouch and sealed on the top. A dry cell with the capacity of 1000 mAh was obtained, then the dry cell was dried 16 hours in a vacuum chamber at 85° C.

Electrolyte compositions were prepared under an argon atmosphere in a dry box with a 3:7 weight ratio of ethylene carbonate (EC): ethylmethyl carbonate (EMC), solvent containing 1 mol/L LiPF₆. Various amounts of additives were added to the 1.0M electrolyte solution, as indicated in the Examples below. The compositions were prepared in glass vials with teflon screw caps. The comparative and inventive formulations 1-6 further contain additives as listed in table 1 below. Percent additives are weight percent, based on the total composition. The electrolyte compositions were injected into the dry cells in a vacuum chamber. After sealing, first charging, degassing, aging, the cells were conducted with following two tests:

### Test 1: HT 55° C. Cycle Life Test

The cell was put in the chamber and kept at the temperature of 55° C. Charging the cell at a constant current rate of 3 C (3000 mA) to 2.7 V, then charging at a constant voltage of 2.7V until the current is less than or equal to 50 mA. The cell was then discharged at a constant current rate of 3 C (3000 mA) until the cut-off voltage 1.5V is reached. Capacity retention after 1000 cycles at 55° C. for the electrolyte formulations are shown in table 1.

### Test 2: HT Storage Test

After 3 cycles of charge and discharge between1.5V-2.7V at room temperature, the cell was charged into 100% SOC and the initial thickness (T1) of the cell was measured with vernier calipers. Then the cell was stored 10 days in the hot chamber of 60° C. After storing, the thickness (T2) is recorded and the cell's swelling is calculated by following formulation:

Swelling=(T2−T1)/T1*100

TABLE 1
Results of swell and capacity retention tests

| | | | | | HT | |
|---|---|---|---|---|---|---|
| | | | | | 60° C.@10 days | HT 55° C. |
| | | LiDFOB | DTD | SA | storage | 1 C/1 C@1000 cycles |
| | LTO Anode | (%) | (%) | (%) | Swelling | Capacity retention |
| Example 1 | Carbon-coated | | | | 15% | 75% |
| | LTO | | | | | |
| Example 2 | Carbon-coated | 2 | | | 6% | 86% |
| | LTO | | | | | |
| Example 3 | Carbon-coated | | 1 | | 8% | 84% |
| | LTO | | | | | |
| Example 4 | Carbon-coated | | | 0.5 | 10% | 79% |
| | LTO | | | | | |
| Example 5 | Carbon-coated | 2 | 1 | | 4% | 90% |
| | LTO | | | | | |
| Example 6 | Carbon-coated | 2 | 1 | 0.5 | 0 | 92% |
| | LTO | | | | | |
| Comparative | LTO | | | | 40% | 60% |
| Example 1 | | | | | | |

* DTD is 1,3,2-dioxathiolane 2,2-dioxide;
LiDFOB is lithium difluoro oxalate borate;
SA is succinic anhydride.

The inventive electrolyte compositions provide less swelling (less gassing) and better electrochemical performance compared to a comparative example. Example 1 can also serve as a comparative example for Example 2-6 to compare the effect of different additives. Examples 2-4 can serve as comparative examples of Example 6.

1. A lithium ion battery comprising at least one cathode, at least one anode comprising LTO having an optional surface coating, and an electrolyte composition,
where the electrolyte composition comprises an organic solvent, one or more lithium salts, one or more SEI forming additives selected from the group consisting of a) alkali metal salts of borates, b) organoboron compounds, c) imides, d) sulfates and e) sulfites; and one or more moisture removing additives selected from the group consisting of f) anhydrides g) nitriles, h) tertiary amines, and i) amides.

2. The battery according to claim 1, wherein the one or more SEI forming additives a)-e) are selected from the group consisting of
a) lithium salts of borates;
b) organoboron compounds of formula 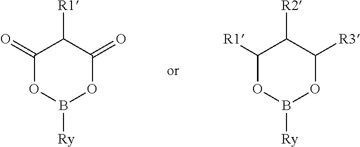
wherein Ry is hydrogen, alkoxy or hydrocarbyl and R1′, R2′ and R3′ are hydrogen or hydrocarbyl;
c) fluorosulfonyl imides;
d) sulfates of formula 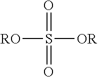
wherein the R groups are hydrocarbyl or together are hydrocarbylene; and
e) sulfites of formula 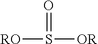
wherein the R groups are hydrocarbyl or together are hydrocarbylene;
and where the one or more moisture removing additives f)-i) are selected from the group consisting of
f) anhydrides of formula 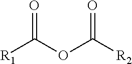
wherein R₁ and R₂ are independently hydrocarbyl or together are hydrocarbylene;
g) nitriles of formula
R₁—CN or NC-Rz-CN
wherein R₁ is hydrocarbyl and Rz is hydrocarbylene;
h) tertiary amines of formula NR₁R₂R₃ wherein R₁, R₂ and R₃ are each hydrocarbyl or wherein R₁ and R₂ and/or R₁ and R₃ and/or R₂ and R₃ together are hydrocarbylene; and
i) amides of formula 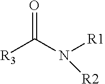
wherein R₁, R₂ and R₃ are each hydrocarbyl or wherein R₁ and R₂ and/or R₁ and R₃ and/or R₂ and R₃ together are hydrocarbylene;

3. The battery according to claim 1, wherein the one or more SEI forming additives a)-e) are selected from the group consisting of
a) lithium bis (oxalate) borate (LiBOB), lithium malonic acid oxalate borate (LiMOB), lithium difluoro oxalate borate (LiDFOB), lithium bis[1,2-benzenediolato(2-)-O,O′]borate (LBBB), lithium bis[2,3-naphthalenediolato(2-)-O,O′]borate (LBNB), lithium bis[2,2′-biphenyldiolato(2-)-O,O′]borate (LBBPB) and lithium bis[salicylato(2-)]borate (LBSB), lithium bis (2,3-pyridinedicarboxylic oxy) borate (LBPB), lithium trifluoroacetic acid perfluoro-substituted phenyl (LiBF3C6F5), or lithium bismalonic borate(LiBMB);
b) 4,4,6-trimethyl-1,3,2-dioxaborinane, 2-methoxy-4,4,6-trimethyl-1,3,2-dioxaborinane, 2-ethoxy-4,4,6-trimethyl-1,3,2-dioxaborinane, 2-isopropoxy-4,4,6-trimethyl-1,3,2-dioxaborinane, 2-butoxy-4,4,6-trimethyl-1,3,2-dioxaborinane, vinylboronic acid 2-methyl-2,4-pentanediol ester, phenylboronic acid neopentylglycol ester, or phenylboronic acid 1,3-propanediol ester;
c) Lithium bis(fluorosulfonyl) imide (LiFSI) or lithium bis(perfluoromethylsulfonyl)imide (LiTFSI);
d) 1,3,2-dioxathiolane 2,2-dioxide (ethylene sulfate, DTD), 1,3-propanediol cyclic sulfate, or 4-methyl-1,3,2-dioxathiolane 2,2-dioxide; and
e) Ethylene sulfite, or trimethylene sulfite;
and the one or more moisture removing additives f)-i) are selected from the group consisting of
f) succinic anhydride (SA), glutaric anhydride (GA), phthalic anhydride (PA), acetic anhydride, maleic anhydride, naphthalic anhydride, propionic anhydride, citraconic anhydride, butyric anhydride, 3,4,5,6-tetrahydrophthalic anhydride, isatoic anhydride, valeric anhydride, or propylphosphonic anhydride;
g) acetonitrile, propionitrile, butyronitrile, isobutyronitrile, 1,2-dicyanoethane, succinonitrile, 1,5-dicyanopentane, hexanedinitrile (adiponitrile), glutaronitrile, or fumaronitrile;
h) triethylamine, tributylamine, N,N,N′,N″,N″-pentamethyldiethylenetriamine, N,N,N′,N″,N′″,N′″-hexamethyltriethylenetetraamine, N,N,N′,N′-tetramethylethylenediamine, or triethylenediamine; and
i) N,N-dimethyl acetamide, N,N-dimethyl-trifluoroacetamide, N,N-diethyl-trifluoroacetamide, N-methyl-trifluoracetamide, 1-methyl-2-pyrrolidinone, or hexamethylphosphoramide;

4. The battery according to claim 1 comprising one or more SEI forming additives a) alkali metal salts of borates.

5. The battery according to claim 1 comprising one or more SEI forming additives d) sulfates.

6. The battery according to claim 1 comprising one or more moisture removing additives f) anhydrides.

7. The battery according to claim 1 comprising one or more additives a), one or more additives d), and optionally one or more additives f).

8. The battery according to claim 1 wherein the cathode comprises lithium transition metal oxide or lithium transition metal phosphate.

9. The battery according to claim 1 wherein the LTO contains a surface coating comprising carbon, AlF₃, or Al₂O₃.

10. The battery according to claim 1 wherein the organic solvent comprises one or more organic carbonates selected from the group consisting of ethylene carbonate, propylene carbonate, trimethylene carbonate, 1,2-butylene carbonate, dimethyl carbonate, diethyl carbonate, ethylmethyl carbonate, dipropyl carbonate, vinylene carbonate, difluoroethylene carbonate and monofluoroethylene carbonate.

11. The battery according to claim 1 wherein the lithium salts are selected from the group consisting of LiPF₆, LiClO₄, LiN(CF₃SO₂)₂, LiAsF₆, LiCF₃SO₃ and LiBF₄ and wherein the lithium salts in total are present in the organic solvent at a level of from about 0.5 M to about 2.5 M based on the solvent.

12. The battery according to claim 1 wherein additives a)-i), in total, are present from about 0.01 to about 15%, by weight, based on the total weight of the electrolyte composition and wherein the weight: weight ratio of the SEI forming additives a)-e) to the moisture removing additives f)-i) is from about 1:9 to about 9:1.

13. The battery according to claim 1 comprising one or more further additives selected from the group consisting of vinylene carbonate (1,3-dioxol-2-one), 4-vinyl-1,3-dioxolan-2-one, 4-fluoro-1,3-dioxolan-2-one, methylene ethylene carbonate, 1,3-propane sultone, 1,4-butyl sultone, prop-1-ene-1,3-sultone, 4-(4-methye-1,3,2-dioxathiolane-2-oxide), 1,5,2,4-dioxadithiane-2,2,4,4-tetraoxide and ionic liquids.

14. A method to reduce gassing and/or to improve capacity retention for LTO type lithium ion batteries at elevated temperature, the method comprising employing an electrolyte composition comprising an organic solvent, one or more lithium salts, one or more SEI forming additives selected from a group consisting of a) alkali metal salts of borates, b) organoboron compounds, c) imides, d) sulfate and e) sulfite; and one or more moisture removing additives selected from the group consisting of f) anhydrides, g) nitriles, h) tertiary amines, i) amides.

15. A lithium ion battery comprising at least one cathode, at least one anode comprising LTO having an optional surface coating, and an electrolyte composition, where the electrolyte composition comprises an organic solvent, one or more lithium salts, and one or more additives selected from a group consisting of 1,3,2-dioxathiolane 2,2-dioxide (ethylene sulfate, DTD), 1,3-propanediol cyclic sulfate, and 4-methyl-1,3,2-dioxathiolane 2,2-dioxide.

16. The battery according to claim 2, wherein the one or more SEI forming additives a)-e) are selected from the group consisting of
a) lithium bis (oxalate) borate (LiBOB), lithium malonic acid oxalate borate (LiMOB), lithium difluoro oxalate borate (LiDFOB), lithium bis[1,2-benzenediolato(2-)-O,O′]borate (LBBB), lithium bis[2,3-naphthalenediolato(2-)-O,O′]borate (LBNB), lithium bis[2,2′-biphenyldiolato(2-)-O,O′]borate (LBBPB) and lithium bis[salicylato(2-)]borate (LBSB), lithium bis (2,3-pyridinedicarboxylic oxy) borate (LBPB), lithium trifluoroacetic acid perfluoro-substituted phenyl (LiBF3C6F5), or lithium bismalonic borate(LiBMB);
b) 4,4,6-trimethyl-1,3,2-dioxaborinane, 2-methoxy-4,4,6-trimethyl-1,3,2-dioxaborinane, 2-ethoxy-4,4,6-trimethyl-1,3,2-dioxaborinane, 2-isopropoxy-4,4,6-trimethyl-1,3,2-dioxaborinane, 2-butoxy-4,4,6-trimethyl-1,3,2-dioxaborinane, vinylboronic acid 2-methyl-2,4-pentanediol ester, phenylboronic acid neopentylglycol ester, or phenylboronic acid 1,3-propanediol ester;
c) Lithium bis(fluorosulfonyl) imide (LiFSI) or lithium bis(perfluoromethylsulfonyl)imide (LiTFSI);
d) 1,3,2-dioxathiolane 2,2-dioxide (ethylene sulfate, DTD), 1,3-propanediol cyclic sulfate, or 4-methyl-1,3,2-dioxathiolane 2,2-dioxide; and
e) Ethylene sulfite, ortrimethylene sulfite;
and the one or more moisture removing additives f)-i) are selected from the group consisting of
f) succinic anhydride (SA), glutaric anhydride (GA), phthalic anhydride (PA), acetic anhydride, maleic anhydride, naphthalic anhydride, propionic anhydride, citraconic anhydride, butyric anhydride, 3,4,5,6-tetrahydrophthalic anhydride, isatoic anhydride, valeric anhydride, or propylphosphonic anhydride;
g) acetonitrile, propionitrile, butyronitrile, isobutyronitrile, 1,2-dicyanoethane, succinonitrile, 1,5-dicyanopentane, hexanedinitrile (adiponitrile), glutaronitrile, or fumaronitrile;
h) triethylamine, tributylamine, N,N,N′,N″,N″-pentamethyldiethylenetriamine, N,N,N′,N″,N′″,N′″-hexamethyltriethylenetetraamine, N,N,N′,N′-tetramethylethylenediamine, or triethylenediamine; and
i) N,N-dimethyl acetamide, N,N-dimethyl-trifluoroacetamide, N,N-diethyl-trifluoroacetamide, N-methyl-trifluoracetamide, 1-methyl-2-pyrrolidinone, or hexamethylphosphoramide.

17. The battery according to claim 2 comprising one or more SEI forming additives a) alkali metal salts of borates.

18. The battery according to claim 2 comprising one or more SEI forming additives d) sulfates.

19. The battery according to claim 2 comprising one or more moisture removing additives f) anhydrides.

20. The battery according to claim 2 comprising one or more additives a), one or more additives d), and optionally one or more additives f).
